(19) United States
(12) Patent Application Publication
(10) Pub. No.: US 2006/0106131 A1
(43) Pub. Date: May 18, 2006

(54) Ink or paint composition comprising a hyperbranched anionic polyesteramide and a combination with a substrate comprising a hyperbranched cationic polyesteramide

(76) Inventor: John Michael Edmunds, Blaenafon (GB)

Correspondence Address: NIXON & VANDERHYE, PC, 901 NORTH GLEBE ROAD, 11TH FLOOR, ARLINGTON, VA, 22203, US

(21) Appl. No.: 10/545,802

(22) PCT Filed: Feb. 19, 2004
(86) PCT No.: PCT/GB04/00650

§ 371 Date: Sep. 26, 2005

(30) Foreign Application Priority Data
Feb. 20, 2003 (GB) 030876.7

(51) Int. Cl. C03C 17/00; C09D 11/00

(52) U.S. Cl. 523/160; 523/161

(57) ABSTRACT

An ink or paint formulation, but in particular an ink formulation, which comprises a hyperbranched polyesteramide is described and claimed. In particular, the formulation will comprise (i) a colorant, (ii) a hyperbranched polyesteramide and (iii) a solvent. The hyperbranched polyesteramide used is suitably chemically “matched” to a coating in the substrate to which the formulation is to be applied, so that they bond together strongly, and combinations of formulations and substrates are also claimed.

The present invention relates to a formulation which is suitable for use as a longevity or permanent ink or paint.

In conventional inks, the colourant which is normally a dye or pigment, constitutes only 2-8% of the total weight by ink (wt %). It is dissolved or suspended in a solvent such as water, alcohols and/or methyl ethyl ketone. Solvents usually constitute from 20-80 wt % of the ink.

Conventional inks include a large number of additional components which may include surfactants, penetrants, solubilizing agents, dispersants, humectants, viscosity modifiers, pH buffers, chelating agents, biocides, u.v. blockers, antioxidants, and free radical inhibitors, depending upon the properties required for the final ink.

Surfactants and penetrants are added to lower surface tension of the ink and to promote penetration (wetting) into the substrate. A frequently used surfactant is Tergitol 15-S-5, a secondary alcohol ethoxylate made by Union Carbide, and isopropyl alcohol is used as penetrant. Usually 0.1-2.0 wt % surfactant, and 1-5 wt % penetrant are included in ink formulations.

Solubilizing agents or “co-solvents”, such as N-methyl pyrrolidone, are added to promote dye solubility in the primary solvent. This allows the loading of the dye to be increased so as to enhance the ink's optical density. Further it holds the dye solution, even at increased concentrations, for example as occurs during evaporation at a nozzle, for example. Usually 2-5 wt % of co-solvent is included in an ink formulation.

Dispersants are added to assist the colloidal suspension of a pigment. Derussol carbon black made by Degussa, is a particular example of a dispersant used in ink formulations. They are usually present in an amount of from 3-8 wt %.

Humectants are added to inhibit evaporation. Glycols are typically added to aqueous inks for this purpose. The amounts of these reagents in the formulation is usually in the range of from 10-30 wt %

Viscosity modifiers may be added in order to increase the surface tension, so that droplet size can be controlled. The reagents used are frequently similar to those which may be used as humectant like glycols and they may typically be present in an amount of from 1 to 3 wt %. However, these also have the effect of raising the viscosity. High viscosity is generally a problem because it may result in clogging of ink jets.

Often pH buffers are included, in particular to maintain a slightly basic pH as this improves ink-metal compatability and so reduces corrosion of a printer's metal parts. Further pH changes influence colour shifts. Triethylamine may be used as buffer, for example, usually in an amount of from 0.1-1.0 wt %.

Chelating agent, such as ethyldiaminetetra-acetic acid, may be added to complex metal ions to prevent scale build-up where ink may evaporate. Where present, they usually constitute from 0.1-0.5 wt % of the ink formulation. Another possible component is a biocide, which kills bacterial and other organisms. One example is 1,2-benzisothiazolin-3-one, available from Zeneca as PROXEL GXL, for example. The amount of biocide added will depend upon the particular compound being used by is usually in the range of from 0.1-0.3 wt %. UV Blockers, antioxidants and/or free radical inhibitors may be added to promote light-fastness, or to prevent degradation of long-chain dye molecules, and usually constitute from 1-5 wt %.

The above list is not exhaustive as some inks may include additional components depending upon the properties required for the final product. Thus these are complex mixtures.

Hyperbranched polyesteramides have recently become available and are used as binders and rheology modifiers in coating technology.

The applicant has found however that by including these compounds in an ink or a paint formulation, the formulation may be substantially simplified, as many of the previous components can be omitted. Furthermore, systems may be designed in which the formulation “matches” a formulation of a coating included in a substrate such as paper or card, such that the formulation will bind tightly to the substrate. Where the formulation is an ink formulation, it may therefore bind tightly to a substrate comprising paper or card.

The invention provides an ink or paint formulation which comprises a hyperbranched polyesteramide.

As used herein, the expression “hyperbranched polyesteramides” refers to compounds which include more than one ester group, more than one amide group and is of a branched chain structure with more than two “end groups. They are suitably low molecular weight polymeric materials.

Thus examples of these compounds may be represented as formula (I) 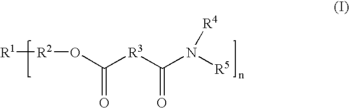
where R¹ is a bridging group,
R² and R³, each of which may be the same or different, are independently selected from an optionally substituted hydrocarbyl group which is optionally interposed with one or more groups selected from —C(O)O—, —OC(O)—, —C(O)NR⁶— and —NR⁶C(O)—;
and R⁴, R⁵ and R⁶, each of which may be the same or different, are independently selected from hydrogen or hydrocarbyl groups which are optionally substituted with a terminal hydrophilic or hydrophobic group;
and n is an integer of 3 or more; provided that at least some of the groups R⁴ and R⁵ teminate with a hydrophilic or hydrophobic group.

The term “hydrocarbyl” as used herein, refers to any structure comprising carbon and hydrogen atoms. In particular, it will comprises an alkyl group.

As used herein, the term “alkyl” refers to straight or branched chain alkyl groups, suitably containing up to 20 and preferably up to 6 carbon atoms.

Suitable optional substituents for hydrocarbyl groups R² or R³ are functional groups. The term “functional group” refers to reactive groups such as halo, cyano, nitro, oxo, C(O)ₙR^{a}, OR^{a}, S(O)ₜR^{a}, NR^{b}R^{c}, OC(O)NR^{b}R^{c}, C(O)NR^{b}R^{c}, OC(O)NR^{b}R^{c}, —NR⁷C(O)OR⁶, —NR^{a}CONR^{b}R^{c}, —C═NOR^{a}, —N═CR^{b}R^{c}, S(O)ₜNR^{b}R^{c} or —NR^{b}S(O)ₜR^{a} where R^{a}, R^{b} and R^{c} are independently selected from hydrogen or optionally substituted hydrocarbyl, or R^{b} and R^{c} together form an optionally substituted ring which optionally contains further heteroatoms such as S(O)ₛ, oxygen and nitrogen, t is an integer of 1 or 2, s is 0 or an integer of 1-2, and any nitrogen atom may be protonated to form a quaternary ammonium salt.

Suitable optional substituents for hydrocarbyl groups R⁴, R⁵ or R⁶ are functional groups which are hydrophilic or hydrophobic in nature. In particular hydrophilic groups are hydroxy or carboxy groups.

Suitable hydrophobic groups are hydrocarbyl groups such as alkyl groups, or perhaloalkyl groups such as trifluoromethyl.

Other possible substituents for groups R⁴, R⁵ and R⁶ include fatty acid esters, acetate, benzoate, tertiary amines such as dialkylamines, polyethylene oxide, polypropylene oxide, alicyclic or heterocyclic groups. As used herein, the expression “heterocyclic” refers to aromatic, non-aromatic or partially aromatic mono, bi- or tri-cyclic ring structures including for example, from 3 to 20 atoms, at least one of which is a heteroatom selected from oxygen, nitrogen or sulphur.

The group R¹ may comprise a single atom provided the valency is 3 or more. Thus it may comprise nitrogen, carbon or sulphur. In the case of carbon or sulphur, where n is 3, there is may be spare valency which are suitably occupied by hydrogen or hydrocarbyl groups.

Where n is greater than 3, R¹ may comprise a linking hydrocarbyl group, which may include one or more heteroatoms such as nitrogen. In this case, the hydrocarbyl group may again be interposed with one or more groups selected from —C(O)O—, ——OC(O)—, —C(O)NR⁶— and —NR⁶C(O)—, where R⁶ is as defined above.

For use in the context of the present invention, it is preferred that the hyperbranched polyesteramide has a balance of hydrophilic: hydrophobic terminal groups of a similar order to that found in Hybrane P2 and Hybrane P4, discussed below.

Hyperbranched polyesteramides based upon anhydrides such as maleic anhydride or succinic anhydride and diisopropanolamine.

These are available from DSM (Netherlands) under the tradenames PreTop®, TopBrane®, and Hybrane®. They are low molecular weight polymers which contain hydrophilic and hydrophobic end groups and the balance between these may be varied depending desired properties of the mixture. PreTop® is an ionic polymer, whereas TopBrane® is non-ionic in nature and versions of Hybrane® are either non-ionic or anionic in nature.

In particular, the hyperbranched polyesteramide is anionic in nature, as many substrates such as paper include surface cationic groups, and this therefore allows the formation of ionic bonds.

An example of a typical polymer of this type is illustrated as formula (A) although variants of this structure are possible.

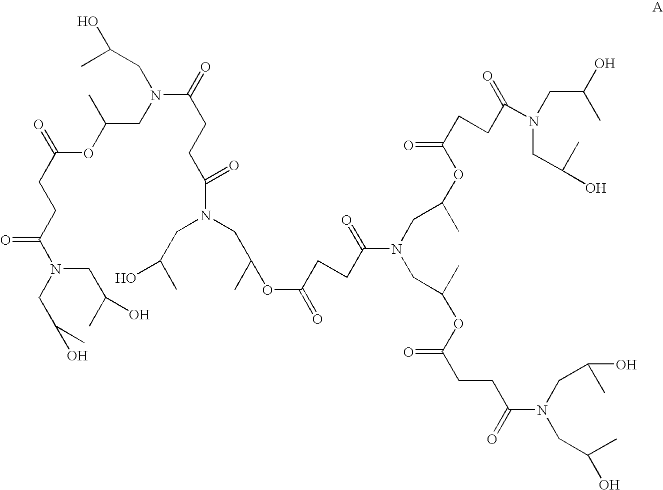

When used in accordance with the invention in an ink or paint formulation, they may effectively replace many of the additional reagents conventionally employed in these compositions. In particular, the applicants have found that the addition of further surfactants, penetrants, solubilizing agents, and dispersants can be avoided by appropriate use of a hyperbranched polyesteramide.

Particular examples of such polymers which may be useful in the context of the present invention are sold as HyBrane S1, Hybrane P1, Hybrane P2 and Hybrane P4 from DSM. Preferred examples are Hybrane P2 and Hybrane P4 and most preferably Hybrane P2. According to the present invention, there is provided an ink or paint formulation comprising (i) a colorant, (ii) a hyperbranched polyesteramide and (iii) a solvent.

Colorants used in the invention may be pigments or dyes, and are preferably pigments. Most preferably the colorant or dye is present in an amount of from 2 to 20% w/w and preferably from 4-10% w/w.

Examples of black dyes include Food Black 2 or preferably the second generation dyes where some of the four sulfonic groups are replaced by carboxylic groups, so as to make the dye less water-soluble so that it will aggregate upon contact with acid paper. These dyes are suitably metallized, which metal atoms such as copper and nickel, which stabilise the dye molecule and so as to improve light-fastness.

A particularly preferred black colorant is the pigment, carbon black.

Suitably blue colorants include first generation cyan dyes (e.g., Acid blue 9), which are based on the triphenylmethane structure, or the more light-fast copper phthalocyanine dyes, such as CI Direct Blue. The copper phthalocyanine used is suitably in pigment form and may have sulfonic groups incorporated to transform it into a water-soluble dye.

The first generation of magenta dyes were xanthene, such as CI Reactive Red 180. Light stability can be further improved by metallizing the dye as done in the CI Reactive Red 23 dye. Typical magenta pigments are quinacridones, such as CI Pigment Red 122 and naphthol AS pigments such as CI Pigment Red 184.

Typical yellow dyes are CI Direct Yellow 86, CI Direct Yellow 132, CI Acid Yellow 23 and CI Acid 17. Representative yellow pigments are monoazo yellow (CI pigment Yellow 74), benzimidazolone yellow (CI pigment Yellow 154), and diarylide yellow (CI Pigment Yellow 13) and any of these may be used as a colorant in the formulation of the invention.

Suitable hyperbranched polyesteramides for use in the ink or paint formulation are as described above. It is suitably present in an amount of from 5 to 30% w/w, for example from 8-12% w/w and typically at about 10% w/w.

The solvent is suitably selected from water or an organic solvent such as an alcohol, in particular a C₁₋₆alkyl alcohol, or a ketone such as methyl ethyl ketone. Where the solvent is water, it is suitably present in an amount of from 45-65% w/w.

The formulation may further comprise one or more additional components as required. In particular it may comprise one or more of the following:

(i) a pH buffer such as a triethylamine buffer, suitably in an amount of from 0.1-1.0 wt %;

(ii) a chelating agent such as ethyldiaminetetra-acetic acid, suitably in an amount of from 0.1-0.5 wt %;

(iii) a biocide such as 1,2-benzisothiazolin-3-one, suitably in an amount of from 01.-0.3 wt %;

(iv) a u.v. blocker such as 4-(dimethylamino)benzoic acid suitably in an amount of from 1-5 wt %,

(v) an antioxidant, suitably in an amount of from 1-5 wt %,

(vi) free radical inhibitor, suitably in an amount of from 1-5 wt %,

(vii) a humectant such as a glycol, suitably in an amount of 1.0 wt %,

(viii) viscosity modifier such as a glycol, for instance ethylene glycol, suitably in an amount of from 1-3 wt %.

Suitably the composition comprises at least one, and preferably all of items (ii), (iii) or (iv) as listed above.

In particular the formulation of the invention is an ink formulation.

Preferably the ink or paint formulation, but particularly an ink formulation, further comprises silica particles. The silica is suitably sub-micron silica and most preferably of 0.3 μm or less, for example from 0.3 μm-0.1 μm, in diameter. Most preferably the silica gel is of a porous nature, for example a found in a silica gel. It may have dye incorporated therein. This is suitably achieved by mixing dye with the porous silica under reduced pressure or vacuum conditions.

For instance a suspension of porous silica in water, wherein the water is preferably present in an amount of from 50-60% w/w is formed, and a dye concentrate added in approximately equal volume to the volume of water. This is then mixed under reduced pressure of vacuum conditions which removes air from the system and including pores within the silica particles. This facilitates absorption of the dye into the pores. At the same time, a substantial portion of the water evaporates leaving a silica/dye concentrate.

The silica itself is transparent and so the dye coloration remains entirely visible. The silica protects the dye for example from mechanical abrasion, and so improves the permanence of an formulation containing this material.

The thus formed concentrate is then suitably added to a mixture of the hyperbranched polyesteramide and dye in water. Other desired components as listed above may suitably be added to form an ink or paint formulation. Preferably the final formulation contains from 2-20% w/w silica and preferably from 10-15% silica.

The superior binding of the formulation as a result of the inclusion of the hyperbranched polyesteramide means that the silica particles become adhered to the substrate.

In a further aspect, the invention comprises a combination of a substrate and an ink or paint formulation for administration to the substrate, wherein the substrate has incorporated therein, or coated thereon, a first hyperbranched polyester amide, and the said ink or paint formulation comprises a second hyperbranched polyesteramide which binds to said first hyperbranched polyesteramide.

For example, it is preferably if one of the first and second hyperbranched polyesteramides is anionic in nature and the other is cationic, so that the interaction which forms between them is strong.

In particular in this combination, the formulation is an ink formulation and the substrate is a suitable substrate therefore.

The substrate for which the treatment composition of the invention is intended may be any substrate which may subsequently be printed on. It is preferably of a flexible material and in flat planar or “sheet” form. It may be porous or non-porous. Examples include paper (whether wood-based or otherwise), fabric (either natural or synthetic) and plastics films such as are used in packaging and glass. Clearly this list is not exhaustive. The substrate may already carry a surface coating or other treatment, such as a protective (for example, UV-resistant, fire resistant, water-proofing) or decorative (for example, metallic) coating.

The hyperbranched polyester amide compound may be applied to the substrate using any known coating or impregnation process. It may for example be applied using the process described in copending International Patent Application No WO 02/064888.

Suitably the formulations and in particular the ink formulations used in the above system are as described above.

A further aspect of the invention comprises a method for printing on a substrate, said method comprising applying to the substrate an ink or paint formulation as described above, and in particular an ink formulation.

The following Examples illustrate the invention.

### COMPARATIVE EXAMPLE

A typical standard ink base formulation comprises the following components.

TABLE 1

| Requirements | Details | wt % |
|---|---|---|
| Aqueous Dye Colorant | Combination of dyes* | 3.00% |
| Surfactant | Tergitol 15-9-5 = alcohol | 0.70% |
| | ethoxylate | |
| Penetrant | Isopropyl.alcohol | 2.00% |
| Solubilising Agent | N-methyl.pyrrolidone | 3.50% |
| Dispersant | DISPERSE-AYD W-30 | 5.00% |
| Humectant | Glycol | 15.00% |
| Viscosity Modifier | DAPRO W-77 | 3.00% |
| PH Buffer | Triethylamine | 0.10% |
| Chelating Agent | EDTA (Ethyldiamine Tetra- | 0.25% |
| | acetic acid) | |
| Biocide | 2 Benzisothiazolin-3-one | 0.10% |
| | (Zeneca) PROXEL_GLX | |
| UV - Blocker, Antioxident, | | 3.00% |
| Free Radical inhibitor | | |
| Solvent | De-ionised/Distilled Water | 64.35% |
| Total | | 100.00% |

*Selected to obtain the desired colour - most colours are produced by combinations of dyes.

### EXAMPLE 1

Ink-Jet Dye Based Ink Formulation

The formulation was prepared as follows.

A combination of dyes chosen to obtain best gamut, colour depth, and durability of colours were selected. Sufficient dyes to achieve the required colour and density was used, and a standard ink base formulation, as described above, was prepared. The viscosity/surface tension of this was selected to match that of the OEM ink for the particular printer technology used.

A second composition was then prepared by blending the same dye combination as for the standard ink formulation with the Hydra P2/P4 to achieve a viscosity 3% lower than the base but with an increase of colour density by 15% and an increase of 1% in the surface tension.

The second formulation was then blended into the standard ink formulation in a vacuum mixer with short bursts of high shear. The resultant formulation had the following composition.

TABLE 2

| Requirements | Details | wt % |
|---|---|---|
| Aqueous Dye Colorant | Combination of dyes | 4.00% |
| Surfactant | Tergitol 15-9-5 = alcohol | 0.70% |
| | ethoxylate | |
| Penetrant | Isopropyl.alcohol | 1.50% |
| Solubilising Agent | N-methyl.pyrrolidone | 3.00% |
| Dispersant | Hydra P2/P4 | 10.00% |
| Humectant | Glycol | 15.00% |
| Viscosity Modifier | DAPRO W-77 | 1.50% |
| PH Buffer | Triethylamine | 0.10% |
| Chelating Agent | EDTA (Ethyldiamine Tetra- | 0.33% |
| | acetic acid) | |
| Biocide | 2 Benzisothiazolin-3-one | 0.12% |
| | (Zeneca) PROXEL_GLX | |
| UV - Blocker, Antioxident, | | 3.00% |
| Free Radical inhibitor | | |
| Solvent | De-ionised/Distilled Water | 60.75% |
| Total | | 100.00% |

This formulation was found to be a very good waterproof ink.

### EXAMPLE 2

Particle Inkjet Formulation

The formulation was prepared as follows.

A combination of dyes chosen to obtain best gamut, colour depth, and durability of colours were selected. Sufficient dyes to achieve the required colour and density were used, and a standard ink base formulation, as described above, was prepared. The viscosity/surface tension of this was selected to match that of the OEM ink for the particular printer technology used.

A second composition was then prepared by blending the same dye combination as for the standard ink formulation with the Hydra P2/P4. This second composition was then blended with a fine particle silica gel (so as to match the solids density of the relevant OEM ink) in a hi-vacuum mixer (−3 bar) with a medium speed-blending whisk for 30 minutes and then slow down to a quarter speed for 45 minutes.

This product was then blended the standard ink base formulation n a vacuum mixer with short bursts of high speed. Mix ratio was 10% by weight, to achieve a viscosity 3% lower than the base but with an increase of colour density by 15% and an increase of 1% in the surface tension.

The resultant formulation comprised the following:

TABLE 3

| Requirements | Details | wt % |
|---|---|---|
| Aqueous Dye Colorant | Combinations of dyes | 5.00% |
| Surfactant | Tergitol 15-9-5 = alcohol | 0.70% |
| | ethoxylate | |
| Penetrant | Isopropyl.alcohol | 2.00% |
| Solubilising Agent | N-methyl.pyrrolidone | 3.50% |
| Dispersant | Hydra P2/P4 | 10.00% |
| Humectant | Glycol | 15.00% |
| Viscosity Modifier | DAPRO W-77 | 3.00% |
| PH Buffer | Triethylamine | 0.10% |
| Chelating Agent | EDTA (Ethyldiamine Tetra- | 0.25% |
| | acetic acid) | |
| Biocide | 2 Benzisothiazolin-3-one | 0.10% |
| | (Zeneca) PROXEL_GLX | |
| UV - Blocker, | | 3.00% |
| Antioxident, Free Radical | | |
| inhibitor | | |
| Silica Gel Particles | Particle size 0.3 of a micron | 2.00% |
| Solvent | De-ionised/Distilled Water | 55.35% |
| Total | | 100.00% |

1-20. (canceled)

21. An ink or paint formulation which comprises a hyperbranched polyesteramide.

22. A formulation according to claim 21 wherein the hyperbranched polyesteramide is anionic.

23. An ink or paint formulation comprising (i) a colorant, (ii) a hyperbranched polyesteramide and (iii) a solvent.

24. A formulation according to claim 21 which further comprises silica particles.

25. A formulation according to claim 24 wherein the silica particles are of 0.3 μm or less in average diameter.

26. A formulation according to claim 24 wherein the silica particles are porous.

27. A formulation according to claim 26 wherein the silica particles have dye incorporated therein.

28. A formulation according to claim 21 wherein the hyperbranched polyesteramide is present in the formulation in an amount of from 5 to 30% ww.

29. A formulation according to claim 21 which further comprises one or more items selected from the group consisting of:
(i) a pH buffer;
(ii) a chelating agent;
(iii) a biocide;
(iv) a u.v. blocker;
(v) an antioxidant;
(vi) free radical inhibitor;
(vii) a humectant; and
(viii) a viscosity modifier.

30. A formulation according to claim 29 which comprises at least one of items (ii), (iii) and (iv).

31. A formulation according to claim 30 which comprises all three of items (ii), (iii) and (iv).

32. A formulation according to claim 21 which is an ink formulation.

33. A method of forming a formulation according to claim 24 which comprises the steps of mixing a dye concentrate with a silica gel and water under reduced pressure, until a silica/dye concentrate is obtained, adding this concentrate to a solution comprising a hyperbranched polyesteramide.

34. A combination of a substrate and an ink or paint formulation for administration to the substrate, wherein the substrate has incorporated therein, or coated thereon, a first hyperbranched polyester amide, and the said ink formulation comprising a second hyperbranched polyesteramide which binds to said first hyperbranched polyesteramide.

35. A combination according to claim 34 wherein one of the first and second hyperbranched polyesteramides is anionic in nature and the other is cationic.

36. A combination according to claim 34 wherein the formulation is an ink formulation.

37. A combination according to claim 34 wherein the substrate is selected from paper (whether wood-based or otherwise), fabric (either natural or synthetic) and plastics films or glass.

38. A combination according to claim 34 wherein the substrate has a surface coating.

39. A combination according to claim 38 wherein the coating is a protective or decorative coating.
